(19) United States
(12) Patent Application Publication
(10) Pub. No.: US 2007/0254758 A1
(43) Pub. Date: Nov. 1, 2007

(54) Hub assembly for bicycle

(75) Inventor: Ching-Shu Chen, Changhua City (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: Chosen Co., Ltd., Changhua Hsien (TW)

(21) Appl. No.: 11/645,954

(22) Filed: Dec. 27, 2006

(30) Foreign Application Priority Data
Apr. 28, 2006 (TW) 095207292

(51) Int. Cl. F16H 55/30; F16H 55/12

(52) U.S. Cl. 474/160

(57) ABSTRACT

A hub assembly for a bicycle includes a hub body provided with a mounting portion, a freewheel slidably mounted on the mounting portion of the hub body, and at least one retainer mounted on the mounting portion of the hub body and rested on the freewheel to retain the freewheel on the mounting portion of the hub body to prevent the freewheel from being detached from the mounting portion of the hub body. Thus, the freewheel is slidable on the mounting portion of the hub body to change the position of the freewheel relative to the chainwheel, so that the freewheel is in line with the chainwheel, and the chain is perpendicular to the hub body constantly without incurring deflection.

### BACKGROUND OF THE INVENTION

1. Field of the Invention

The present invention relates to a hub assembly and, more particularly, to a hub assembly for a bicycle.

2. Description of the Related Art

A conventional hub assembly for a bicycle in accordance with the prior art shown in FIGS. 7-10 comprises a hub body 60 having a side provided with an outer threaded section 601, and a freewheel 61 having an inner wall formed with an inner threaded section 611 screwed onto the outer threaded section 601 of the hub body 60 and an outer wall formed with a plurality of driven teeth 612.

In assembly, referring to FIG. 9, the hub assembly is mounted on a bicycle which comprises a bottom bracket axle 63, a crank 62, a chainwheel 65, a chain 64, a chain stay 66 and a wheel 67. The hub body 60 is rotatably mounted on the chain stay 66, the wheel 67 is mounted on the hub body 60, the chainwheel 65 is mounted on the bottom bracket axle 63, the crank 62 is mounted on the bottom bracket axle 63 to rotate the chainwheel 65, and the chain 64 intermeshes with the chainwheel 65 and the driven teeth 612 of the freewheel 61.

In operation, referring to FIGS. 7-9, when the crank 62 is rotated on the bottom bracket axle 63, the chainwheel 65 is rotated to drive the chain 64 which rotates the freewheel 61 which rotates the hub body 60 to rotate the wheel 67 so as to move the bicycle forward. In addition, the hub body 60 has an inside containing a oneway ratchet wheel (not shown) and a bearing (not shown). Thus, when the freewheel 61 stops rotating (when the crank 62 stops rotating) or when the rotation speed of the wheel 67 is greater than that of the freewheel 61 (when the bicycle is moved on the downward slope), the rotation speed of the ratchet wheel is greater than that of the freewheel 61, so that the ratchet wheel is rotatable relative to the freewheel 61 to rotate the hub body 60 and the wheel 67 so as to move the bicycle forward successively by the clutch action of the ratchet wheel. Thus, the ratchet wheel is rotatable relative to the freewheel 61 and is not rotated by the freewheel 61 so that the freewheel 61 performs an idling rotation. Thus, the ratchet wheel and the hub body 60 are not rotated by the freewheel 61 and will not interfere with rotation of the freewheel 61 and the crank 62. When the rotation speed of the freewheel 61 is greater than that of the wheel, the ratchet wheel and the hub body 60 are rotated by the freewheel 61 again.

When the bicycle is used for racing or performance, the bicycle needs to provide different bottom bracket axles having different sizes and specification due to the necessity of racing or performance, so that the position of the chainwheel 65 is changed to correspond to different positions of the different bottom bracket axles.

However, when the position of the chainwheel 65 is changed, the freewheel 61 is not aligned with the chainwheel 65, so that the chain 64 intermeshing with the chainwheel 65 and the freewheel 61 is deflected as shown in FIG. 10. Thus, when the chain 64 is deflected, the force applied by the chain 64 on the hub body 60 is not distributed evenly and smoothly, thereby affecting the normal operation of the hub body 60. In addition, the force applied by the chain 64 on the hub body 60 is not distributed evenly and smoothly, so that the bearing in the hub body 60 is easily worn out due to a stress concentration, thereby decreasing the lifetime of the hub body 60.

### BRIEF SUMMARY OF THE INVENTION

In accordance with the present invention, there is provided a hub assembly, comprising a hub body having a side provided with a mounting portion, a freewheel slidably mounted on the mounting portion of the hub body, and at least one retainer mounted on the mounting portion of the hub body and rested on the freewheel to retain the freewheel on the mounting portion of the hub body to prevent the freewheel from being detached from the mounting portion of the hub body.

The primary objective of the present invention is to provide a hub assembly having a position adjustment function.

Another objective of the present invention is to provide a hub assembly, wherein the freewheel is slidable on the mounting portion of the hub body to change the position of the freewheel relative to the chainwheel, so that the freewheel is in line with the chainwheel, and the chain is perpendicular to the hub body constantly without incurring deflection.

A further objective of the present invention is to provide a hub assembly, wherein the chain is perpendicular to the hub body constantly without incurring deflection, so that the force applied by the chain on the hub body is distributed evenly and smoothly, thereby facilitating the normal operation of the hub body, and thereby enhancing the lifetime of the hub body.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a hub assembly in accordance with the preferred embodiment of the present invention.

FIG. 2 is an exploded perspective view of the hub assembly as shown in FIG. 1.

FIG. 3 is a top view of the hub assembly for a bicycle as shown in FIG. 1.

FIG. 4 is a locally cross-sectional enlarged view of the hub assembly for a bicycle as shown in FIG. 3.

FIG. 5 is an exploded perspective assembly view of a hub assembly in accordance with another preferred embodiment of the present invention.

FIG. 6 is an exploded perspective assembly view of a hub assembly in accordance with another preferred embodiment of the present invention.

FIG. 7 is a perspective view of a conventional hub assembly in accordance with the prior art.

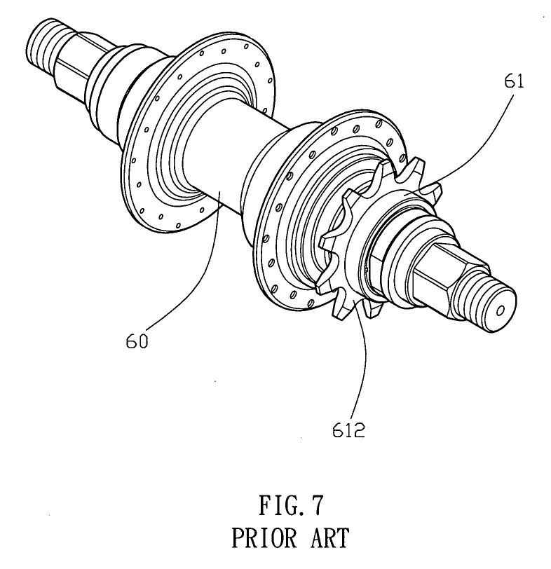

FIG. 8 is an exploded perspective view of the conventional hub assembly as shown in FIG. 7.

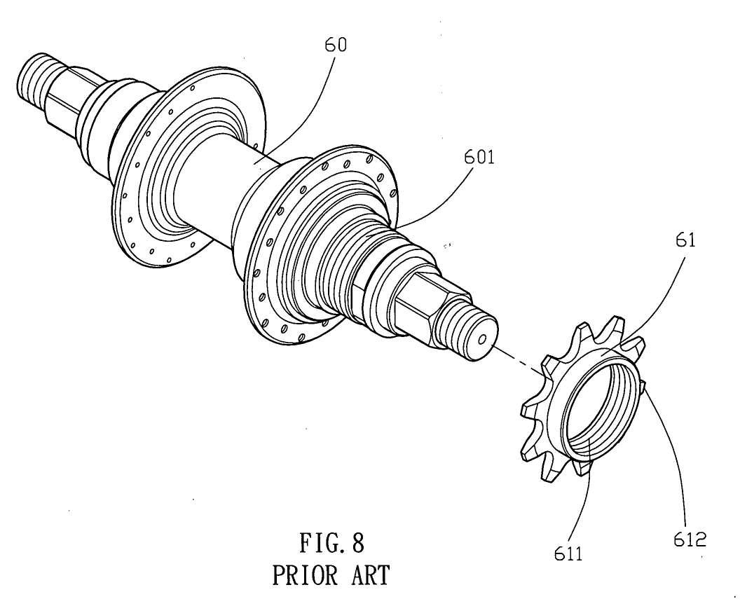

FIG. 9 is a top view of the conventional hub assembly for a bicycle as shown in FIG. 7.

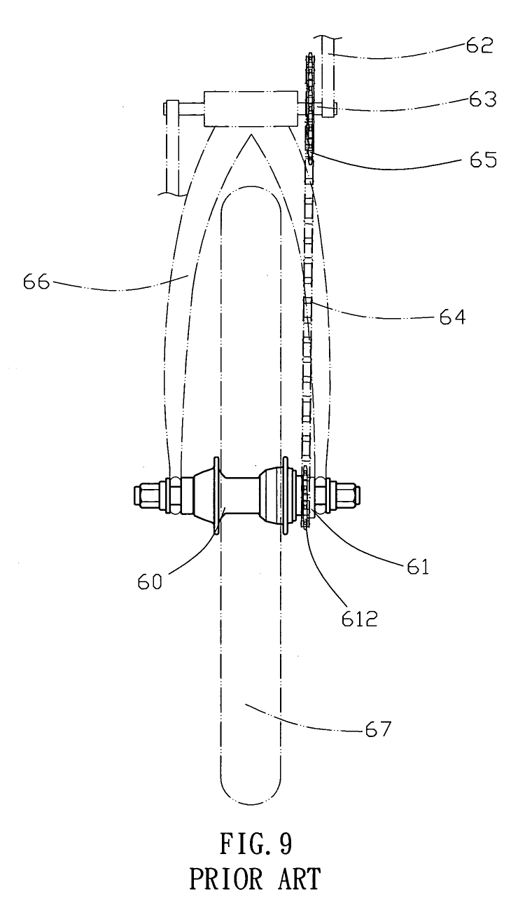

FIG. 10 is a locally cross-sectional enlarged view of conventional the hub assembly for a bicycle as shown in FIG. 9.

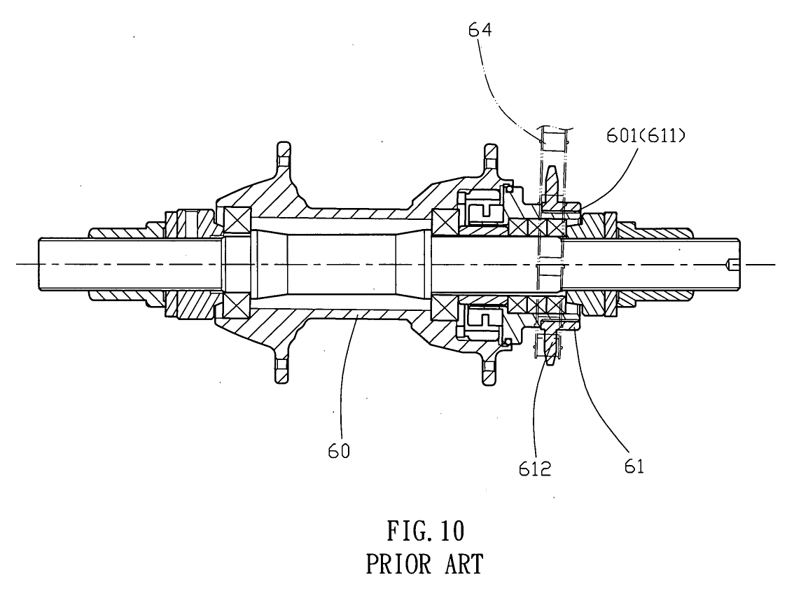

### DETAILED DESCRIPTION OF THE INVENTION

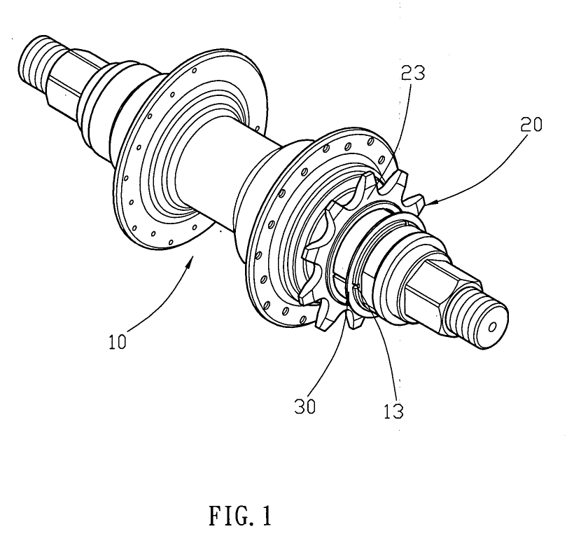

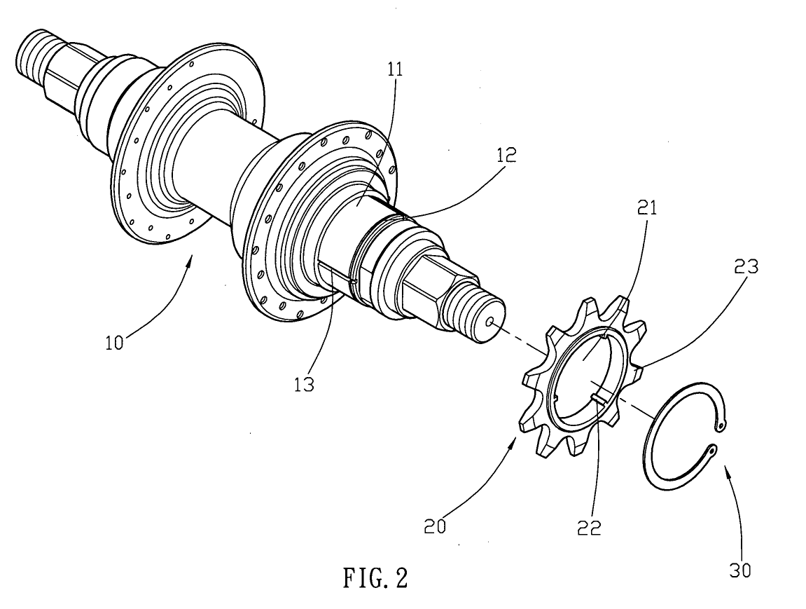

Referring to the drawings and initially to FIGS. 1 and 2, a hub assembly for a bicycle in accordance with the preferred embodiment of the present invention comprises a hub body 10 having a side provided with a mounting portion 11, a freewheel 20 slidably mounted on the mounting portion 11 of the hub body 10, and at least one retainer 30 mounted on the mounting portion 11 of the hub body 10 and rested on the freewheel 20 to retain the freewheel 20 on the mounting portion 11 of the hub body 10 to prevent the freewheel 20 from being detached from the mounting portion 11 of the hub body 10.

In the preferred embodiment of the present invention, the mounting portion 11 of the hub body 10 has a peripheral wall formed with a plurality of positioning grooves 13 which are equally spaced from each other. Each of the positioning grooves 13 is extended in the axial direction of the mounting portion 11 of the hub body 10 and through a whole length of the mounting portion 11 of the hub body 10. The mounting portion 11 of the hub body 10 has a distal end formed with at least one annular retaining groove 12 connected to the positioning grooves 13.

The freewheel 20 is slidable on the mounting portion 11 of the hub body 10 to translate along an axial direction of the mounting portion 11 of the hub body 10. The freewheel 20 has an inner wall formed with a plurality of radially and inwardly extending positioning ribs 22 each inserted into and positioned in a respective positioning groove 13 of the hub body 10 and an outer wall formed with a plurality of driven teeth 23. The positioning ribs 22 of the freewheel 20 are equally spaced from each other to correspond to the positioning grooves 13 of the hub body 10. Each of the positioning ribs 22 of the freewheel 20 is extended in an axial direction of the freewheel 20 and through a whole length of the inner wall of the freewheel 20. Each of the positioning ribs 22 of the freewheel 20 is slidable in a respective positioning groove 13 of the hub body 10. The inner wall of the freewheel 20 is formed with a mounting hole 21 mounted on the mounting portion 11 of the hub body 10.

The retainer 30 is preferably a substantially C-shaped snap ring. The retainer 30 is retained in the retaining groove 12 of the hub body 10.

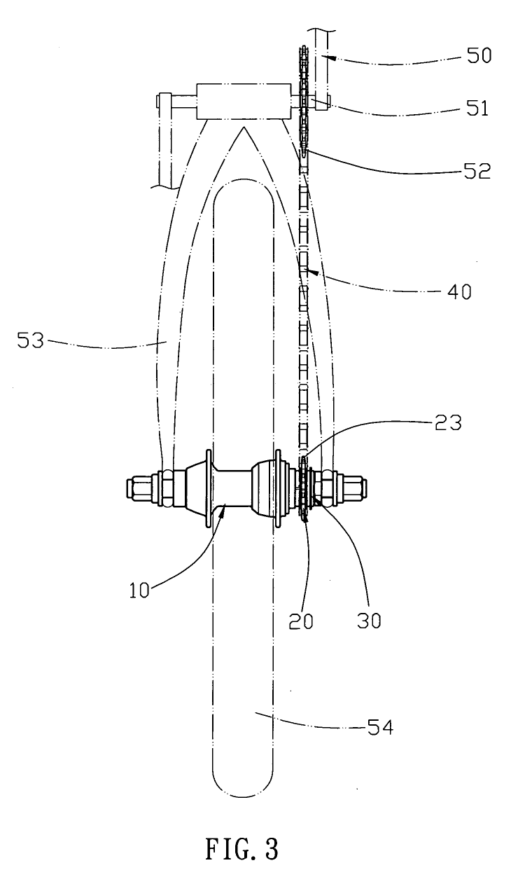

In assembly, referring to FIG. 3, the hub assembly is mounted on a bicycle which comprises a bottom bracket axle 51, a crank 50, a chainwheel 52, a chain 40, a chain stay 53 and a wheel 54. The hub body 10 is rotatably mounted on the chain stay 53, the wheel 54 is mounted on the hub body 10, the chainwheel 52 is mounted on the bottom bracket axle 51, the crank 50 is mounted on the bottom bracket axle 51 to rotate the chainwheel 52, and the chain 40 intermeshes with the chainwheel 52 and the driven teeth 23 of the freewheel 20.

In operation, referring to FIGS. 1-3, when the crank 50 is rotated on the bottom bracket axle 51, the chainwheel 52 is rotated to drive the chain 40 which rotates the freewheel 20. At this time, the positioning ribs 22 of the freewheel 20 are positioned in the positioning grooves 13 of the hub body 10, so that the hub body 10 is rotated by the freewheel 20 to rotate the wheel 54 so as to move the bicycle forward.

In addition, the hub body 10 has an inside containing a oneway ratchet wheel (not shown) and a bearing (not shown). Thus, when the freewheel 20 stops rotating (when the crank 50 stops rotating) or when the rotation speed of the wheel 54 is greater than that of the freewheel 20 (when the bicycle is moved on the downward slope), the rotation speed of the ratchet wheel is greater than that of the freewheel 20, so that the ratchet wheel is rotatable relative to the freewheel 20 to rotate the hub body 10 and the wheel 54 so as to move the bicycle forward successively by the clutch action of the ratchet wheel. Thus, the ratchet wheel is rotatable relative to the freewheel 20 and is not rotated by the freewheel 20 so that the freewheel 20 performs an idling rotation. Thus, the ratchet wheel and the hub body 10 are not rotated by the freewheel 20 and will not interfere with rotation of the freewheel 20 and the crank 50. When the rotation speed of the freewheel 20 is greater than that of the wheel, the ratchet wheel and the hub body 10 are rotated by the freewheel 20 again.

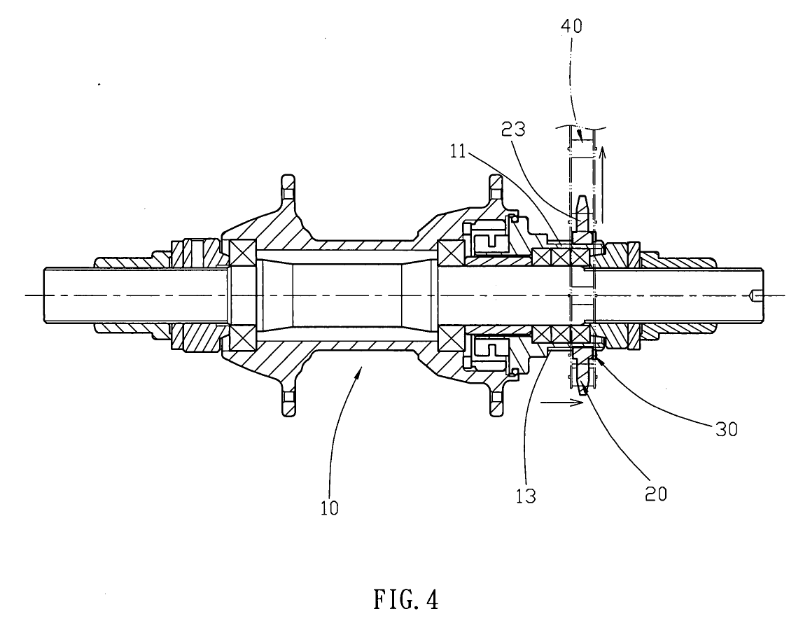

As shown in FIGS. 3 and 4, when the bicycle is provided with a bottom bracket axle 51 having different sizes and specification due to necessity of racing or performance, the position of the chainwheel 52 is changed to correspond to different positions of the bottom bracket axle 51 and the crank 50. At this time, the freewheel 20 is slidable on the mounting portion 11 of the hub body 10 as shown in FIG. 4 to change the position of the freewheel 20 relative to the chainwheel 52, so that the freewheel 20 is in line with the chainwheel 52, and the chain 40 is perpendicular to the hub body 10 constantly without incurring deflection. In addition, the freewheel 20 is tensioned by the chain 40 and the chainwheel 52 after adjustment of the position of the freewheel 20, so that the freewheel 20 cannot translate freely on the mounting portion 11 of the hub body 10, so that the hub body 10 is operated at the horizontal state.

Accordingly, the freewheel 20 is slidable on the mounting portion 11 of the hub body 10 to change the position of the freewheel 20 relative to the chainwheel 52, so that the freewheel 20 is in line with the chainwheel 52, and the chain 40 is perpendicular to the hub body 10 constantly without incurring deflection. In addition, the chain 40 is perpendicular to the hub body 10 constantly without incurring deflection, so that the force applied by the chain 40 on the hub body 10 is distributed evenly and smoothly, thereby facilitating the normal operation of the hub body 10, and thereby enhancing the lifetime of the hub body 10.

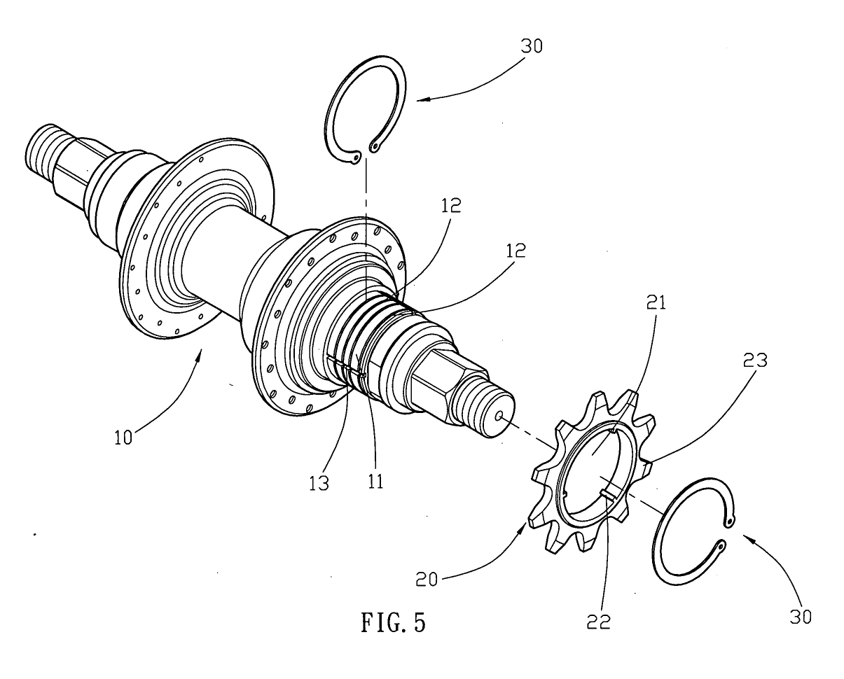

As shown in FIG. 5, the hub assembly comprises two retainers 30 mounted on the mounting portion 11 of the hub body 10, and the freewheel 20 is located between the two retainers 30 to prevent the freewheel 20 from being detached from the mounting portion 11 of the hub body 10. The mounting portion 11 of the hub body 10 is formed with a plurality of annular retaining grooves 12 which are equally spaced from each other and connected to the positioning grooves 13, and each of the two retainers 30 is retained in a respective retaining groove 12 of the hub body 10.

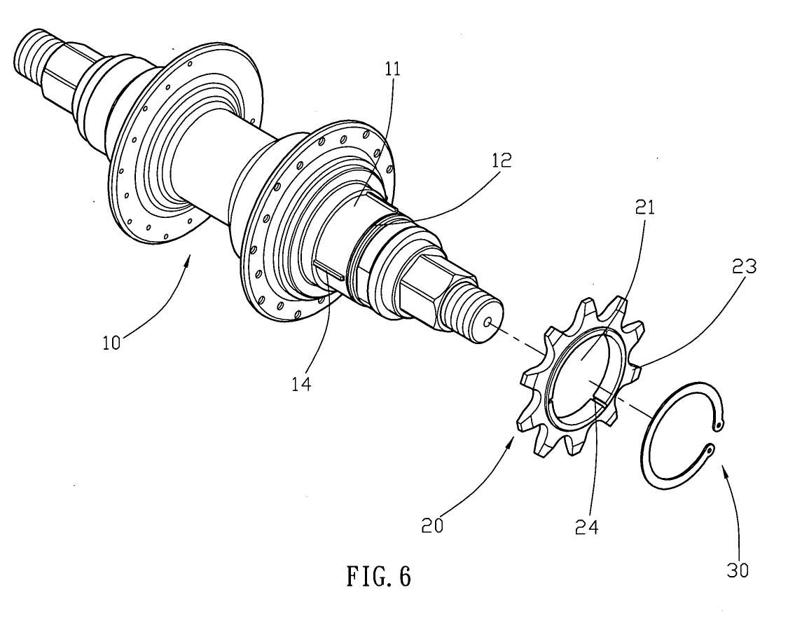

As shown in FIG. 6, the freewheel 20 has an inner wall formed with a plurality of positioning grooves 24 which are equally spaced from each other. Each of the positioning grooves 24 is extended in an axial direction of the freewheel 20 and through a whole length of the inner wall of the freewheel 20. The mounting portion 11 of the hub body 10 has a peripheral wall formed with a plurality of radially and outwardly extending positioning ribs 14 each inserted into and positioned in a respective positioning groove 24 of the freewheel 20. The positioning ribs 14 of the hub body 10 are equally spaced from each other to correspond to the positioning grooves 24 of the freewheel 20. Each of the positioning ribs 14 of the hub body 10 is extended in an axial direction of the mounting portion 11 of the hub body 10 and through a whole length of the mounting portion 11 of the hub body 10. Each of the positioning ribs 14 of the hub body 10 is slidable in a respective positioning groove 24 of the freewheel 20 when the freewheel 20 is slidable on the mounting portion 11 of the hub body 10.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A hub assembly, comprising:
a hub body having a side provided with a mounting portion;
a freewheel slidably mounted on the mounting portion of the hub body;
at least one retainer mounted on the mounting portion of the hub body and rested on the freewheel to retain the freewheel on the mounting portion of the hub body to prevent the freewheel from being detached from the mounting portion of the hub body.

2. The hub assembly in accordance with claim 1, wherein the mounting portion of the hub body has a peripheral wall formed with a plurality of positioning grooves, and the freewheel has an inner wall formed with a plurality of radially and inwardly extending positioning ribs each inserted into and positioned in a respective positioning groove of the hub body.

3. The hub assembly in accordance with claim 2, wherein the positioning grooves of the hub body are equally spaced from each other, and the positioning ribs of the freewheel are equally spaced from each other to correspond to the positioning grooves of the hub body.

4. The hub assembly in accordance with claim 2, wherein each of the positioning grooves is extended in an axial direction of the mounting portion of the hub body.

5. The hub assembly in accordance with claim 2, wherein each of the positioning grooves is extended through a whole length of the mounting portion of the hub body.

6. The hub assembly in accordance with claim 2, wherein each of the positioning ribs of the freewheel is extended in an axial direction of the freewheel.

7. The hub assembly in accordance with claim 2, wherein each of the positioning ribs of the freewheel is extended through a whole length of the inner wall of the freewheel.

8. The hub assembly in accordance with claim 2, wherein each of the positioning ribs of the freewheel is slidable in a respective positioning groove of the hub body.

9. The hub assembly in accordance with claim 1, wherein the freewheel is slidable on the mounting portion of the hub body to translate along an axial direction of the mounting portion of the hub body.

10. The hub assembly in accordance with claim 2, wherein the mounting portion of the hub body has a distal end formed with at least one annular retaining groove, and the retainer is retained in the retaining groove of the hub body.

11. The hub assembly in accordance with claim 1, further comprising a chainwheel mounted on a bottom bracket axle, and a chain intermeshing with the chainwheel and the freewheel, wherein the freewheel is slidable on the mounting portion of the hub body to change a position of the freewheel relative to the chainwheel, so that the freewheel is in line with the chainwheel, and the chain is perpendicular to the hub body constantly without incurring deflection.

12. The hub assembly in accordance with claim 1, wherein the hub assembly comprises two retainers mounted on the mounting portion of the hub body, and the freewheel is located between the two retainers to prevent the freewheel from being detached from the mounting portion of the hub body.

13. The hub assembly in accordance with claim 12, wherein the mounting portion of the hub body is formed with a plurality of equally spaced annular retaining grooves, and each of the two retainers is retained in a respective retaining groove of the hub body.

14. The hub assembly in accordance with claim 1, wherein the freewheel has an inner wall formed with a plurality of positioning grooves, and the mounting portion of the hub body has a peripheral wall formed with a plurality of radially and outwardly extending positioning ribs each inserted into and positioned in a respective positioning groove of the freewheel.

15. The hub assembly in accordance with claim 14, wherein the positioning grooves of the freewheel are equally spaced from each other, and the positioning ribs of the hub body are equally spaced from each other to correspond to the positioning grooves of the freewheel.

16. The hub assembly in accordance with claim 14, wherein each of the positioning grooves is extended in an axial direction of the freewheel and through a whole length of the inner wall of the freewheel.

17. The hub assembly in accordance with claim 14, wherein each of the positioning ribs of the hub body is extended in an axial direction of the mounting portion of the hub body and through a whole length of the mounting portion of the hub body.

18. The hub assembly in accordance with claim 14, wherein each of the positioning ribs of the hub body is slidable in a respective positioning groove of the freewheel when the freewheel is slidable on the mounting portion of the hub body.

19. The hub assembly in accordance with claim 1, wherein the retainer is a substantially C-shaped snap ring.

20. The hub assembly in accordance with claim 10, wherein the retaining groove of the hub body is connected to the positioning grooves.
